(19) United States
(12) Patent Application Publication
(10) Pub. No.: US 2013/0263823 A1
(43) Pub. Date: Oct. 10, 2013

(54) DISC DAMPER FOR CHARGE AIR LINES OF AN INTERNAL COMBUSTION ENGINE HAVING A TURBOCHARGER

(71) Applicants: Dietrich Denker, Ostfildern (DE); Stefan Huth, Solingen (DE)

(72) Inventors: Dietrich Denker, Ostfildern (DE); Stefan Huth, Solingen (DE)

(73) Assignee: UMFOTEC UMFORMTECHNIK GMBH, Northeim (DE)

(21) Appl. No.: 13/880,590

(22) PCT Filed: Oct. 21, 2011
(86) PCT No.: PCT/EP2011/068442

§ 371 Date: Jun. 27, 2013

(30) Foreign Application Priority Data
Oct. 25, 2010 (DE) 10 2010 042 893.0

(51) Int. Cl. F02M 35/10

(52) U.S. Cl. CPC F02M 35/10295
USPC 123/434

(57) ABSTRACT

A disc damper for a charge air line of an internal combustion engine that has a turbocharger. The disc damper includes an inlet, an outlet, and at least one slit chamber disposed between the inlet and outlet. Starting from the inlet, at least two gap chambers are provided downstream of the slit chamber and disposed axially one after the other. At least one of the following features is fulfilled: a) the slit chamber has a radial inner dimension that changes in the circumferential direction and/or b) the slit chamber has axial inner dimensions that change in the circumferential direction, and/or at least one gap chamber comprises radial inner dimensions that change in the circumferential direction.

### CROSS-REFERENCE TO RELATED APPLICATIONS

This application is the U.S. National Phase of International Application No. PCT/EP2011/068442, filed Oct. 21, 2011, which, in turn, claims the benefit of German Application No. DE 10 2010 042 893.0, filed Oct. 25, 2010. The contents of both of these applications are hereby incorporated by reference in their entirety as part of the present disclosure.

### FIELD OF THE INVENTION

The invention relates to a disc damper for charge air lines of an internal combustion engine, which has a turbocharger. The disc damper, which is disposed, in particular, behind the turbocharger, comprises an inlet, an outlet and at least one slit chamber disposed between the inlet and the outlet.

### BACKGROUND OF THE INVENTION

Such a damper or insulator is known from DE 198 55 708 B4. This damper has proved itself in practice but is relatively large. Internal combustion engines with turbochargers, particularly injection engines with turbochargers, are increasingly used in automobile engineering. This leads to engines with an ever smaller cubic capacity and thus, ever smaller dimensions. Thus, construction spaces are also becoming smaller. The space available for sound insulation becomes increasingly smaller.

The operating noises emitted by the engine are to comply with predefined requirements; a good sound of the engine is desired. In the case of turbocharged engines, noises occur due the splitting of charge air within the turbocharger, with further noise added to that. In particular, noises that lie within the human auditory range are supposed to be dampened as much as possible; a desired noise emission is to be accomplished. In this case, the engine developers increasingly demand sound reductions over wide frequency ranges, for example in the range of from 400 to 4000 Hz, with the smallest of construction spaces being provided.

The known damper is configured as a tubular chamber damper. It comprises two slit chambers axially disposed one behind the other. With this, the demanded small dimensions and a minimum damping effect in a sufficiently large frequency range cannot be achieved.

Thus, a damping effect in a sufficiently large frequency range with as small a design as possible is desired. The damper is supposed to be inexpensive to manufacture; it is supposed to be capable of being assembled from components that are easy to produce and mount. Metal and/or suitable plastics are possible materials. A working temperature of 180° C. and above and a pressure of usually 1.8 bars in the damper is to be taken into account.

### SUMMARY OF THE INVENTION

It is therefore the object of the invention to improve the known damper and to develop it further in such a way that it has as small dimensions as possible, can be adapted to narrow construction spaces and is suitable for a wider frequency range.

This object is accomplished by the damper for a charge air line of an internal combustion engine having a turbocharger. The disc damper, comprises an inlet, an outlet, at least one slit chamber disposed between the inlet and the outlet, at least two gap chambers, which are axially disposed one behind the other relative to the inlet, provided between the slit chamber and the outlet and at least one of: the at least one slit chamber has a radial inner dimension that changes in a circumferential direction, the at least one slit chamber has an axial inner dimension that changes in the circumferential direction, and at least one of the gap chambers has a radial inner dimension that changes in the circumferential direction.

By combining at least one inlet-side slit chamber, which, due to its design, is relatively wide-band, and gap chambers disposed behind it, which are also relatively wide-band, a disc damper is obtained which enables a minimum damping effect of 20 dB and above for a sufficiently wide frequency range, e.g. between a ratio of fo/fu greater than or equal to 2, with fu being the lower frequency and fo the upper frequency of the frequency range observed. For example, the frequency range is 400 Hz to 4000 Hz.

In a kinematic reversal, it is also possible to reverse the order of the inlet and outlet. In this case, the design remains the same, only the direction of the flow through the damper is changed.

By combining at least one slit chamber and several gap chambers, each of which are configured to be wide-band by their geometry, a hitherto unknown, relatively small design is achieved with a high degree of insulation that, with regard to the frequency, is continuously wide.

A slit chamber is understood to be a resonator having a slit and a hollow chamber. Via the slit, the hollow chamber is connected with an inner space of the damper and accessible. The slit extends over only a small part of the axial length over which the hollow chamber extends, for example less than 20%, in particular less than 10% of the axial length of the hollow chamber. Slit chambers are also referred to as Helmholtz resonators.

Gap chambers are understood to be resonators having a gap and a cavity. The cavity is accessible over its entire axial length via the gap. Gap chambers are also referred to as lambda/4 resonators. Lambda is the wavelength.

A channel of the inner space extends between the inlet and outlet. It substantially has a constant cross section and is partially defined by a cylinder. The channel communicates with the slit and the gaps. They each preferably extend over a circuit of 360°.

The slit chamber, hereinafter also referred to as primary slit chamber, deviates considerably from the slit chambers according to the prior art. It has radial inner dimensions which, in contrast to the prior art, are not constant over a circuit around the axis of the internal channel, but change considerably. A change by at least 30%, preferably at least 80%, and in particular at least 150% is understood to be a considerable change.

In an alternative, and preferably in combination with the changing radial inner dimension according to the previous paragraph, the slit chamber differs from the prior art in that it has an axial inner dimension that changes considerably over a circuit around the axis of the internal channel. A considerable change is defined as in the previous paragraph.

Due to the radial inner dimension changing considerably over the circuit, the slit chamber can be adapted well in its geometry to the construction spaces required. The slit chamber, and thus also the entire disc damper, can be constructionally designed in such a way that the slit chamber extends to where the engine manufacturer is able to provide free inner space, and fills this free inner space to a greater or smaller extent. Now, no space with a constant radial dimension for the disc damper has to be provided any longer all around the axis of the internal channel. Thus, a construction space in the form of a tube that extends concentrically with the axis of the internal channel and, optionally, extends in a curve or bend, is no longer required. Rather, the disc damper is no longer rotationally symmetric in a radial plane. It can be constructionally designed in such a way that the distance to a first component from the axis of the internal channel, with this component being located in a first angular position, is smaller by the factor two to three than the distance to another component located in a second angular position. The above-mentioned tube enveloping the exterior of the disc damper thus extends with a considerable offset to the axis of the internal channel. The axis of the internal channel now no longer forms the center, but is considerably displaced from the center.

In this case, the above-mentioned tube, and thus the outer contour of the disc damper can have a largely arbitrary shape. The shape can be delimited by a circular line which is considerably eccentric with regard to the axis of the internal channel. The eccentricity is at least 30%, in particular at least 80% of the diameter. The shape can be delimited by a polygon with distinctly rounded-off corners, e.g. by a quadrangle. It can also be delimited by other curves, such as, for example, an ellipse.

The hollow chamber of the primary slit chamber has a defined volume. Viewed in the axial direction, the primary slit chamber has a slit with a substantially constant width in the direction of the circuit; the deviation is less than 80%. The hollow chamber has an irregular distribution of the volume of the hollow chamber about the axis of the internal channel. The invention thus teaches a configuration of the hollow chamber that is adapted to the existing construction spaces. The hollow chamber is supposed to extend to where the existing construction space leaves room for the engine. Where very little construction space is available in practice, the hollow chamber is configured with a smaller radial inner dimension and/or a smaller axial inner dimension.

The gap chambers are also better adapted to the existing construction spaces provided by the engine manufacturer than is the case in the prior art. In a preferred embodiment of the invention over a single circuit around the axis of the internal channel. Therefore, the gap chambers are relatively wide-band. They afford different resonant frequencies distributed over the circuit angle. This causes the desired wide-band properties. The considerable deviation is understood to be the definition given above.

Preferably, the disc damper is disposed in the immediate vicinity of the turbocharger and, in particular, is integrated into the turbocharger to a greater or lesser extent.

The outlet has an outlet axis and the inlet has an inlet axis. The disc damper preferably has an angle of at least 10 degrees, in particular of at least 20 degrees, between the inlet axis and the outlet axis. The disc damper can also be configured to be straight so that its axis runs through in a straight line. It is preferably composed from several straight and/or curved sections.

It is sufficient if any one of the following features is satisfied in a disc damper: the at least one slit chamber has a radial inner dimension that changes in a circumferential direction, the at least one slit chamber has an axial inner dimension that changes in the circumferential direction, and at least one of the gap chambers has a radial inner dimension that changes in the circumferential direction. Preferably, two features are satisfied. The optimum result is obtained, however, if three features are satisfied.

The design of the gap chambers is preferably such that the axial inner dimension is constant, i.e. unchanging over a circuit around the axis line. Preferably, the gap chambers are delimited by lateral walls that lie in planes that extend parallel to one another.

Preferably, the changes of the inner dimensions are continuous, in particular continuously differentiable. The changes are to take place in such a way that, in particular in the case of the gap chambers, a sufficient partial volume of the hollow chamber is available for each individual frequency.

Preferably, the slit chamber and the at least two gap chambers are delimited towards the outside by a jacket having a cross-sectional shape that does not change in the axial direction. In particular, it is delimited by a straight prism.

Other advantages and features become apparent from the description below of two exemplary embodiments of the invention, which are to be understood not to be limiting and which will be explained in detail below with reference to the drawing.

### BRIEF DESCRIPTION OF THE DRAWINGS

FIG. 1 shows a schematic side view of a turbocharger, a disc damper and an engine with a straight axis line;

FIG. 2 shows an axial cross-sectional view of a tubular chamber damper with a non-straight axis line;

FIG. 3 shows a perspective view of the tubular chamber damper according to FIG. 2 with a viewing direction onto the inlet; and

FIG. 4 shows a cross-sectional view along the sectional plane IV-IV in FIG. 2.

### DETAILED DESCRIPTION OF EMBODIMENTS OF THE INVENTION

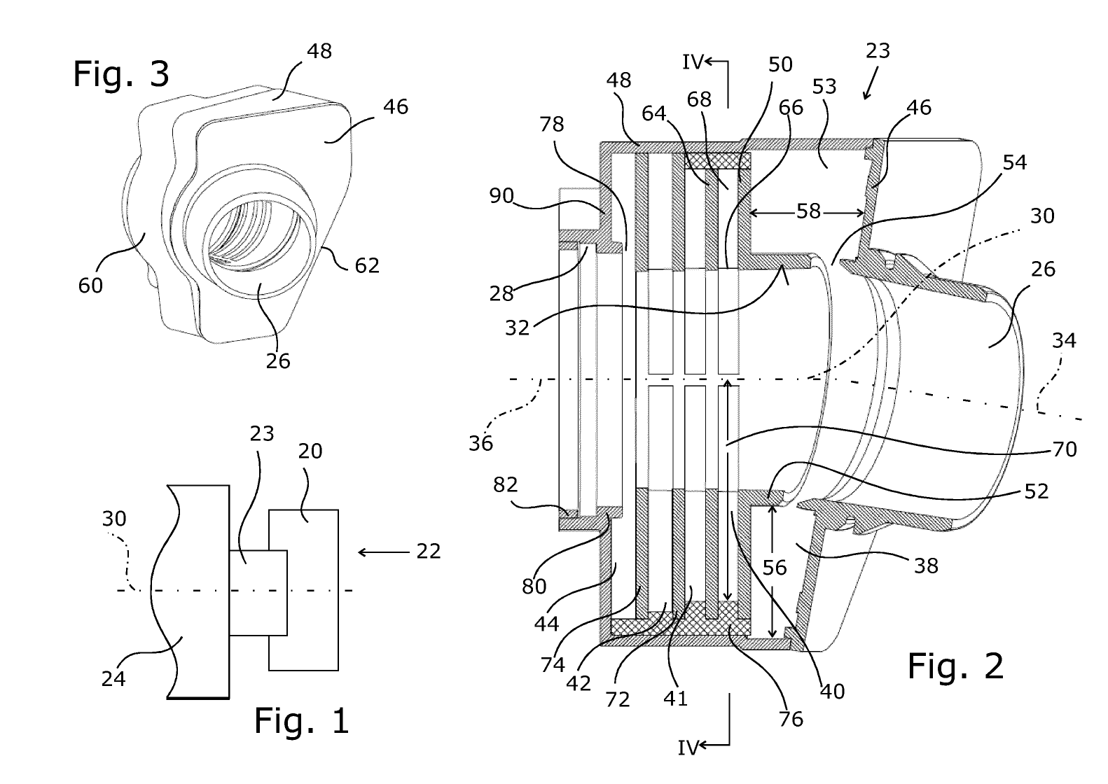

Indicated schematically, FIG. 1 shows a turbocharger 20 with air flowing into it in accordance with an arrow 22. The compressed air flows through a disc damper 23 towards an internal combustion engine 24. The disc damper 23 is a part of a charge air line. Further components of a charge air line can be provided between the internal combustion engine 24 and the turbocharger 20 and/or forward of the turbocharger 20. The damper 23 can also be disposed in a charge air line forward of the turbocharger 20. The damper 23 is partially integrated into the turbocharger 20.

The following also applies to the second exemplary embodiment according to the FIGS. 2 to 4. The disc damper 23 comprises an inlet 26 and an outlet 28. It has an axis line 30 defined as the center line of an internal channel 32. The latter has a substantially constant, round cross-section from the inlet 26 to the outlet 28. On the side of the inlet 26, the axis line 30 coincides with an inlet axis 34. In the region of the outlet 28, the axis line 30 follows an outlet axis 36.

In the case of the second exemplary embodiment, the inlet axis 34 is at an angle of approximately 10° to the outlet axis 36. Other values in a range of from 0-30° are possible.

In the description of the damper 23, the term “front” is used for an object that is closer to the inlet 26 than a part compared therewith. Thus, this is put in relation to the direction of the flow according to the arrow 22.

The damper 23 has a primary slit chamber 38 directly at the outlet 26. It is adjoined by three gap chambers 40, 41, and 42 that are disposed coaxially one behind the other. A secondary slit chamber 44, which is located in the immediate vicinity of an outlet 28, is located behind them.

The primary slit chamber 38 is delimited by a front wall 46, a jacket 48, a rear wall 50 and a pipe section 52. The latter forms a slit 54. This has a slit width measured in the axial direction; the slit width is a function of the circumference. Its width changes approximately by the factor 2. In other words, the smallest slit width, bottom of FIG. 2, and the largest slit width, top of FIG. 2, have a ratio of about 1:2. The slit width changes in proportion to the angle between these two extreme values.

As FIG. 2 shows, the primary slit chamber 38 has a radial inner dimension 56 and an axial inner dimension 58. Both are a function of the angle 59 around the axis line 30. The location at which the radial inner dimension 56 and the axial inner dimension 58 are measured can be chosen freely. However, it applies that the radial inner dimension 56 is measured on a radial plane. In the exemplary embodiment shown, the radial inner dimension 56 is measured parallel to the rear wall 50 and at a constant axial distance therefrom. The radial plane in that case is a radial plane to the rear section of the axis line 30. Alternatively, the radial inner dimension 56 can also be measured parallel to the front wall 46. In that case, the radial plane relates to the front section of the axis line 30, i.e. to the inlet axis 34. Equally, it applies for the axial inner dimension 58 that it is measured on a cylinder jacket whose cylinder axis is a section of the axis line 30. In the exemplary embodiment shown, the cylinder axis is the rear section of the axis line 30, i.e. the outlet axis 36.

The axial inner dimension 58 is set at right angles to the rear wall 50. In an alternative embodiment, measuring can also be done at right angles to the front wall 46. In that case, the axial inner dimension is to be determined on a cylinder jacket around the front section of the axis line 30. Seen over the circumference, i.e. over a circuit of 360°, the two inner dimensions 56 and 58 change continuously and continuously differentiably. In the exemplary embodiment shown, the front wall 46 and the rear wall 50 are at an angle of about 10° relative to one another; they are each plane. This is not necessary. In another embodiment, they may also have a conical extent, be wavy or the like. This particularly applies to the front wall 46, which has a greater degree of freedom with regard to its configuration.

The jacket 48 is substantially a jacket of a straight prism. Seen in cross-section, it has the shape of a square having a bulge 60 on one side and a bevel 62 on the opposite side. On the whole, the result is almost a pentagon. This pentagon has strongly rounded corners. The bevel 62 has been chosen because there is not enough construction space available at the respective location. The axis line 30 is relatively close to the bulge 60; the radial inner dimension 56 is at its smallest there. It has a correspondingly small value also in the region of the bevel 62.

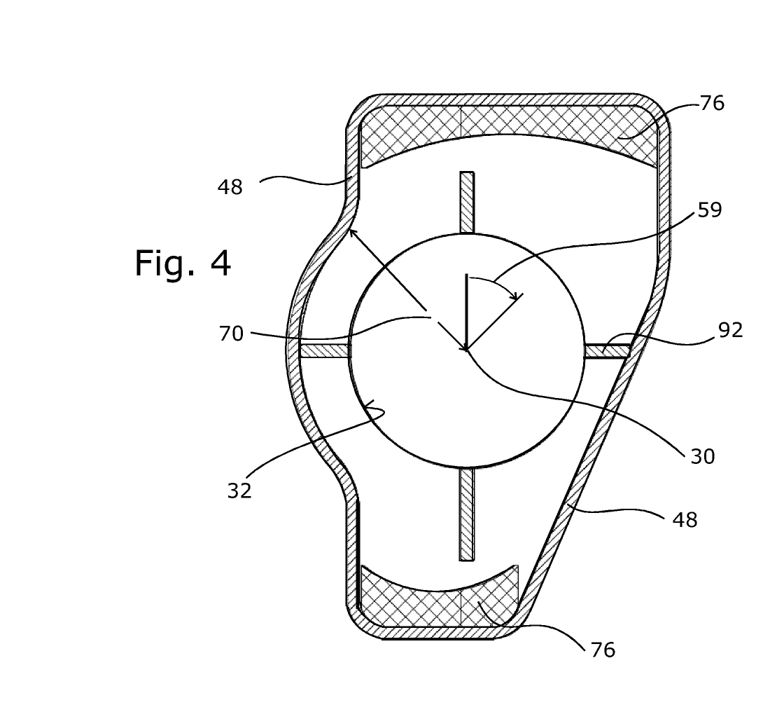

It is apparent from the sectional view according to FIG. 4 that the radial inner dimension has its largest value at an angular position of between 2 and 3 o'clock. The value is also high for the range of between 5 to 7 o'clock. The 12 o'clock position is chosen as the starting point for the measurement of the angle 59.

The three gap chambers 40, 41 and 42 will be addressed below. The first gap chamber 40 is delimited by the rear wall 50 and a first radial wall 64. They both extend in planes that are parallel to one another. The first gap chamber 40 is formed by a gap 66 and a gap chamber 68. This also applies to the second gap chamber 41 and to the third gap chamber 42. A radial inner dimension 70 is a function of the angle at circumference. It changes substantially in the same way as the radial inner dimension 56 of the primary slit chamber 44. In contrast to the primary slit chamber 38, the axial inner dimension of all gap chambers 40 to 42 is constant. In other words, the radial walls 64, 72, 74 extend parallel to one another. The gap chambers 40 to 42 differ in their axial inner dimensions and/or their radial inner dimensions. On the whole, they are attuned to one another in such a way that a frequency range is covered which is above the frequency range of the primary slit chamber 38. Radially outwards, the gap chambers are partially delimited by the jacket 48, but partially also by a link 76 resting against the inner wall of the jacket 48; the link 76 has two sections. Each section covers an angle range of about 20 to 60 degrees. The link 76 does not extend over the entire circumference, for example over only 80°.

The third gap chamber 42 is immediately adjoined by the secondary slit chamber 44. In principle, the secondary slit chamber 44 is configured like the third gap chamber 42, but differs from it in that its access to the hollow chamber takes place via a slit 78 delimited by a collar 80. The latter is concentric with the outlet 28 and connected integrally therewith. A flange of the engine 24 is drawn in at 82.

The secondary slit chamber 44 has a constant axial inner dimension over the entire circumference. The radial inner dimension, however, changes. This change is approximately in accordance with the same function as for the primary slit chamber 38, but is affected by the elastic insert 76 that extends over a partial angle of, for example, 180°. The latter is provided in the primary slit chamber 38 only to such an extent as it fills the gap between the rear wall 50 and the inner face of the jacket 48.

The secondary slit chamber 44 is terminated by a rear wall 90. It also extends parallel to the radial walls 64, 72 and 74.

The link 76 serves for attuning at least a single one of the gap chambers 40-42. In the exemplary embodiment shown, it has two parts. It consists of an upper and a lower link component. The lower link component is located in all three gap chambers 40-42 and also in the secondary slit chamber 44. The upper link component is located in the three gap chambers 40, 41, 42.

Different damping behaviors can be set by means of such a link 76. In principle, a link 76 is not required. It is advantageous in cases where several different internal combustion engines of a single manufacturer, including different sports versions, are to be equipped with different configurations of the disc damper 23 and/or if different properties are required with the same design. In this case, it is convenient if different disc dampers 23 can be manufactured in a simple manner while retaining other components, particularly the jacket 48, all walls, the inlet 26 and the outlet 28. For this case, it is advantageous if, for example, the jacket 48 is made of two parts, so that the at least the one component of the link 76 can be plugged onto an internal unit from the outside, and that then, the half-shells of the jacket 48 are laid over that and closed. Thus, the at least one component of the link 76 is fixed.

An internal component can be inserted during manufacture which forms the rear wall, the first radial wall 64, the second radial wall 72, the third radial wall 74 and the rear section of the pipe section 52, preferably forms them as a single piece. In order to for this internal component to be contiguous, a total of four webs 92 is provided, which are apparent, in particular, from FIG. 4. They extend at the angle positions of 12 o'clock, 3 o'clock, 6 o'clock and 9 o'clock.

1. A disc damper for a charge air line of an internal combustion engine having a turbocharger, the disc damper, comprising:
an inlet;
an outlet;
at least one slit chamber disposed between the inlet and the outlet;
at least two gap chambers, which are axially disposed one behind the other relative to the inlet, provided between the slit chamber and the outlet; and
at least one of:
the at least one slit chamber has a radial inner dimension that changes in a circumferential direction;
the at least one slit chamber has an axial inner dimension that changes in the circumferential direction; and
at least one of the gap chambers has a radial inner dimension that changes in the circumferential direction.

2. The disc damper according to claim 1, wherein the at least two gap chambers comprise three gap chambers, and the three gap chambers comprise chamber walls that extend at right angles to an axis of the disk damper.

3. The disc damper according to claim 1, wherein the slit chamber has a front wall and a rear wall, and that lie in respective planes that intersect at an angle of between approximately 5 to approximately 20 degrees.

4. The disc damper according to claim 1, wherein each gap chamber comprises a gap, a distance between the gaps of an adjacent two of the gap chambers, which are adjacent to each other in an axial direction is smaller than an axial width of the gaps.

5. The disc damper according to claim 1, wherein the gap chambers are delimited by walls that extend parallel to one another.

6. The disc damper according to claim 1, wherein the inlet defines an inlet axis, the outlet defines an outlet axis, and the inlet axis intersects with the outlet axis at an angle greater than about 5 degrees.

7. The disc damper according to claim 1, further comprising a link peripherally delimiting at least one of the gap chambers at least over an angular range.

8. The disc damper according to claim 1, wherein the at least one slit chamber comprises a second slit chamber disposed adjacent to the outlet.

9. The disc damper according to claim 1, wherein a distance in an axial direction between any adjacent two of the gap chambers is substantially identical.

10. The disc damper according to claim 1, wherein the change of the at least one of the the radial inner dimension of the at least one slit chamber, the axial inner dimension of the at least one slit chamber and the radial inner dimension of the at least one of the gap chambers in the circumferential direction over a range of 360 degrees, is at least 1:2.

11. The disc damper according to claim 1, wherein at least two of:
the slit chamber has a radial inner dimension that changes in a circumferential direction;
the slit chamber has an axial inner dimension that changes in the circumferential direction; and
at least one of the gap chambers has a radial inner dimension that changes in the circumferential direction.

12. The disc damper according to claim 1, wherein the slit chamber has a radial inner dimension that changes in a circumferential direction, the slit chamber has an axial inner dimension that changes in the circumferential direction, and at least one of the gap chambers has a radial inner dimension that changes in the circumferential direction.

13. The disc damper according to claim 3, wherein the angle is approximately 10 degrees.

14. The disc damper according to claim 6, wherein the angle is between about 8 degrees and about 25 degrees.

15. The disc damper according to claim 1, wherein a distance in an axial direction between any adjacent two of the gap chambers deviates from a distance in an axial direction of any other adjacent two of the gap chambers by at most about 30%.

16. The disc damper according to claim 10, wherein the change is at least 1:3.

17. The wide-band damper according to claim 1, wherein the turbocharger is arranged behind the wide-band damper.

18. The wide-band damper according to claim 1, wherein the turbocharger is arranged in front of the wide-band damper.
